(19) United States
(12) Patent Application Publication
(10) Pub. No.: US 2008/0201659 A1
(43) Pub. Date: Aug. 21, 2008

(54) Computer system having multipurpose desktops

(75) Inventor: Yi-Hung Shen, Taipei (TW)

Correspondence Address: RABIN & Berdo, PC, 1101 14TH STREET, NW, SUITE 500, WASHINGTON, DC, 20005, US

(73) Assignee: COMPAL ELECTRONICS, INC., Taipei (TW)

(21) Appl. No.: 11/889,839

(22) Filed: Aug. 16, 2007

(30) Foreign Application Priority Data
Feb. 15, 2007 (TW) 96105845

(51) Int. Cl. G06F 3/048

(52) U.S. Cl. 715/778

(57) ABSTRACT

The computer system, used for an operating system and providing desktops for a user to switch, includes a memory, a desktop management unit and a control unit. The memory stores desktop storage units, in which each of the desktop storage units stores a desktop file, and the desktop file includes at least one icon and one wallpaper image. The desktop management unit stores a desktop directory, and the desktop directory records an address of the desktop file stored in each of desktop storage units. The control unit is electrically connected to the memory and the desktop management unit and receives a desktop changing command transmitted by the operating system, so as to read the corresponding desktop file in the memory according to the desktop changing command and the desktop directory and to display the desktop file on the operating system.

### RELATED APPLICATIONS

This application claims priority to Taiwan Application Serial Number 96105845, filed Feb. 15, 2007, which is herein incorporated by reference.

### BACKGROUND

1. Field of Invention

The present invention relates to a computer system. More particularly, the present invention relates to a computer system having multi-purpose desktops for users to switch immediately.

2. Description of Related Art

In a conventional computer operating system, a single user's account only allows one kind of desktop to be shown; that is, when it is necessary to manage data, the user has to set several data files to classify the data, and the classified data files have to be stored as shortcuts and shown on the desktop to be clicked. Therefore, different data files cannot be classified according to the user's operation or preference, such that the user only can place on the desktop all of icons representing the data files, and all of the necessary data files or shortcuts are spread all over the desktop, making it hard when the user searches for the data.

For the foregoing reasons, there is a need for a computer system, which can be provided for users to classify different data files or shortcuts, to make the users find out the required data files or shortcuts more conveniently.

### SUMMARY

It is therefore an object of the present invention to provide a computer system for users to classify different data files or shortcuts and to use the data files or shortcuts more conveniently.

In accordance with one embodiment of the present invention, a computer system is provided. The computer system is used for an operating system and provides a plurality of desktops for a user to switch. The computer system includes a memory, a desktop management unit and a control unit. The memory stores a plurality of desktop storage units, in which each of the desktop storage units stores a desktop file, and the desktop file includes at least one icon and one wallpaper image. The desktop management unit stores a desktop directory, and the desktop directory records an address of the desktop file stored in each of desktop storage units. The control unit is electrically connected to the memory and the desktop management unit and receives a desktop changing command transmitted by the operating system, so as to read the corresponding desktop file in the memory according to the desktop changing command and the desktop directory and to display the desktop file on the operating system.

For the foregoing embodiment of the present invention, the computer system can let the user set and switch the desktops through a single window and select a suitable desktop for a specific purpose, to manage the data conveniently.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 shows a computer system according to one embodiment of the present invention;

FIG. 2 shows an operating flow chart of changing the desktops according to one embodiment of the present invention;

FIG. 3A shows a drafting desktop according to one embodiment of the present invention;

FIG. 3B shows a searching desktop according to one embodiment of the present invention; and

FIG. 4 shows an operating flow chart of changing the icons according to one embodiment of the present invention.

### DESCRIPTION OF THE PREFERRED EMBODIMENTS

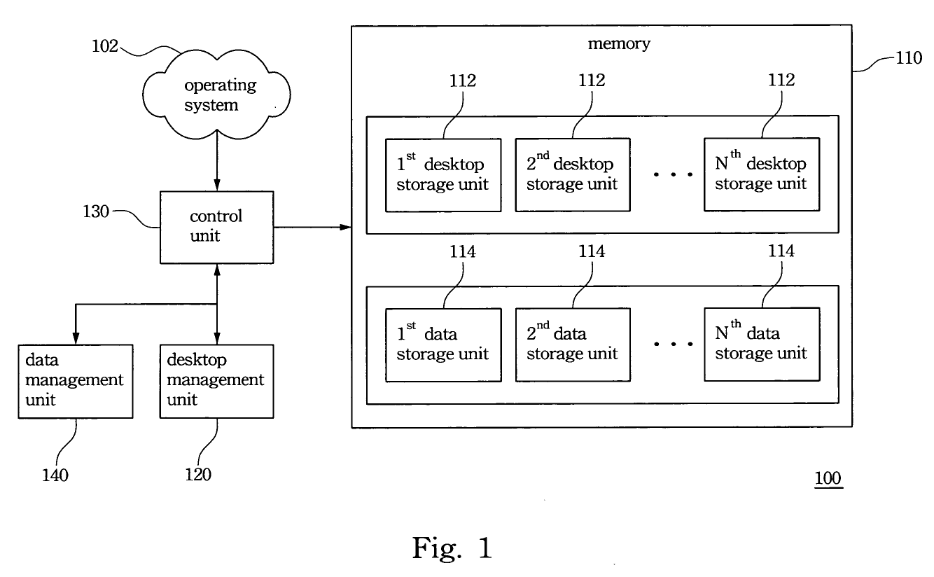

FIG. 1 shows a computer system according to one embodiment of the present invention. The computer system 100 is used for an operating system 102 and provides a plurality of desktops for a user to switch. The computer system 100 includes a memory 110, a desktop management unit 120 and a control unit 130. The memory 110 stores a plurality of desktop storage units 112, in which each of the desktop storage units 112 stores a desktop file, and the desktop file includes at least one icon and one wallpaper image. The desktop management unit 120 stores a desktop directory, in which the desktop directory records an address of the desktop file stored in each of desktop storage units 112. The control unit is electrically connected to the memory 110 and the desktop management unit 120, and receives a desktop changing command transmitted by the operating system 102, so as to read the corresponding desktop file in the memory 110 according to the desktop changing command and the desktop directory stored in the desktop management unit 120, and to display the desktop file on the operating system 102.

Furthermore, the memory 110 stores a plurality of data storage units 114 corresponding to the desktop storage units 112 respectively, in which each of the data storage units 114 stores an icon file representing the icon.

The computer system 100 can further include a data management unit 140, which is electrically connected to the control unit 130 and stores an icon directory, in which the icon directory records an address of the icon file stored in each of data storage units. After receiving an icon changing command transmitted by the operating system 102, the control unit 130 reads the corresponding icon file in the memory 110 according to the icon changing command and the icon directory stored in the data management unit 140, to display the icon file on the operating system 102.

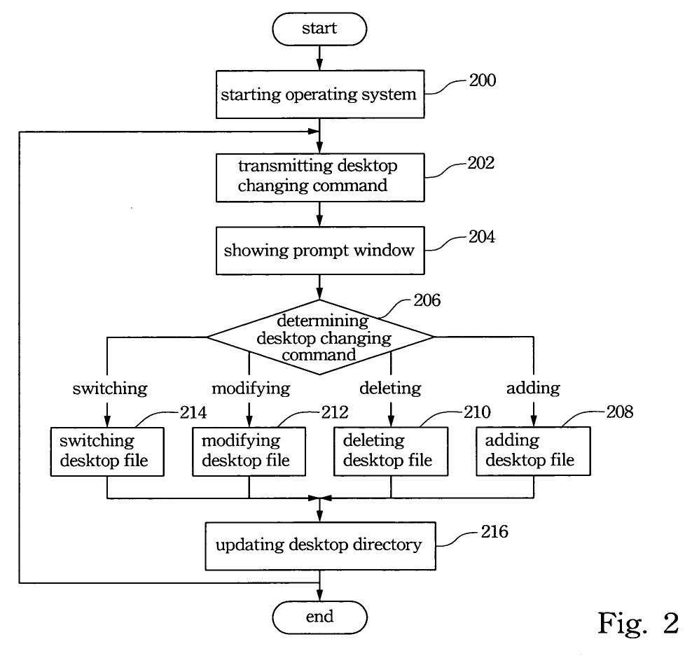

FIG. 2 shows an operating flow chart of changing the desktops according to one embodiment of the present invention. Referring to FIGS. 1 and 2, when the operating system 102 starts, the control unit 130 reads the desktop file, used at the last time, from the memory 110 to display the desktop file on the operating system 102 (Step 200). Then, the desktop changing command is transmitted to the control unit 130 by the operating system 102 (Step 202), so as to change the desktop file displayed on the operating system 102, in which the desktop changing command can be a controlling signal output by a mouse. After that, a prompt window is shown on the desktop displayed on the operating system 102 and is provided for the user to change the desktops (Step 204).

The prompt window, used for changing the desktops, includes an adding command, a deleting command, a modifying command and a switching command shown thereon. When the user would like to change the desktops and selects one of the commands shown on the prompt window, the control unit 130 determines the command the user selects (Step 206). If the user selects the adding command, another desktop file is added (Step 208), and the added desktop file is stored in one of the desktop storage units 112 of the memory 110. If the user selects the deleting command, one of the desktop files designated by the user is deleted (Step 210). If the user selects the modifying command, one of the desktop files designated by the user is modified (Step 212), and the modified desktop file is stored in the corresponding desktop storage unit 112. If the user selects the switching command, the desktop file displayed on the operating system 102 at the moment is switched to another desktop file designated by the user (Step 214). At last, when the user selects and confirms one of the commands to change the desktop, the control unit 130 informs the desktop management unit 120 to update the desktop directory (Step 216). At the moment, if the user would like to change the desktop again, the process reverts back to Step 202; that is, the desktop changing command is re-transmitted to the control unit 130.

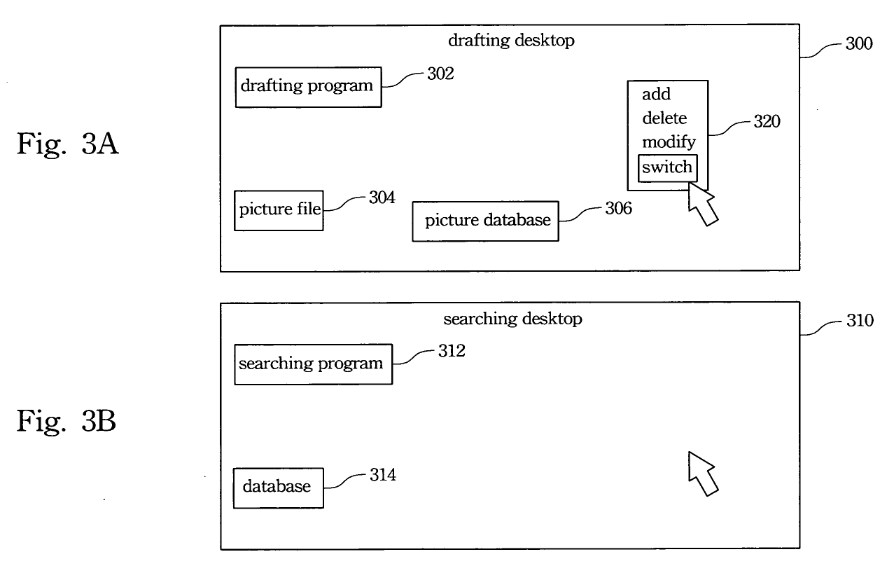

FIG. 3A shows a drafting desktop according to one embodiment of the present invention. FIG. 3B shows a searching desktop according to one embodiment of the present invention. Referring to FIG. 3A and FIG. 3B, the data shown on the drafting desktop includes a drafting wallpaper 300, a drafting program 302, a picture file 304 and a picture database 306, and the data shown on the searching desktop includes a searching wallpaper 310, a searching program 312 and a database 314. When the user controls the mouse to display the prompt window 320 on the drafting desktop and selects the switching command shown on the prompt window 320, the drafting desktop is switched to the searching desktop according to the operating process described above.

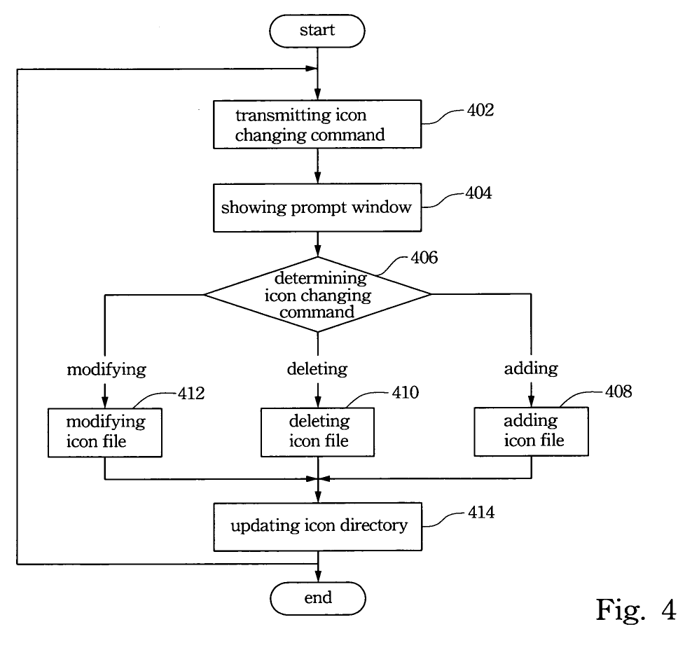

FIG. 4 shows an operating flow chart of changing the icons according to one embodiment of the present invention. Referring to FIG. 1 and FIG. 4, the user can select the icon on the desktop to be changed similarly, and the icon changing command is transmitted to the control unit 130 by the operating system 102 (Step 402), so as to change the icon file displayed on the operating system 102, in which the icon changing command can be a similar controlling signal output by the mouse. After that, another prompt window is shown on the desktop displayed on the operating system 102 and is provided for the user to change the icons (Step 404).

The prompt window, used for changing the icons, includes an adding command, a deleting command and a modifying command. When the user would like to change the icons and selects one of the commands shown on the prompt window, the control unit 130 determines the command the user selects (Step 406). If the user selects the adding command, another icon file is added (Step 408), and the added icon file is stored in one of the data storage units 114 of the memory 110. If the user selects the deleting command, one of the icon files designated by the user is deleted (Step 410). If the user selects the modifying command, one of the icon files designated by the user is modified (Step 412), and the modified icon file is stored in the corresponding data storage unit 114. At last, when the user selects and confirms one of the commands to change the icon, the control unit 130 informs the data management unit 140 to update the desktop directory (Step 414). At the moment, if the user would like to change the icon again, the process reverts back to Step 402; that is, the icon changing command is re-transmitted to the control unit 130.

For the foregoing embodiments of the present invention, the computer system can be provided for the user to classify different data files or shortcuts, to make the user operate on the operating system more conveniently, and can let the user set and switch the desktops through a single window and select a suitable desktop for a specific purpose, to manage the data easily.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A computer system used for an operating system and providing a plurality of desktops for a user to switch, comprising:
a memory storing a plurality of desktop storage units, each of the desktop storage units storing a desktop file comprising at least one icon and one wallpaper image;
a desktop management unit storing a desktop directory, the desktop directory recording an address of the desktop file stored in each of desktop storage units; and
a control unit electrically connected to the memory and the desktop management unit and receiving a desktop changing command transmitted by the operating system, so as to read the corresponding desktop file in the memory according to the desktop changing command and the desktop directory and to display the desktop file on the operating system.

2. The computer system as claimed in claim 1, wherein when the operating system starts, the control unit reads the desktop file used at last time, to display the desktop file on the operating system.

3. The computer system as claimed in claim 2, wherein when the desktop changing command is transmitted by the operating system to the control unit, a prompt window is shown on the desktop displayed on the operating system and is provided for the user to change the desktops.

4. The computer system as claimed in claim 3, wherein the prompt window comprises:
an adding command provided for the user to select to add another desktop file;
a deleting command provided for the user to select to delete one of the desktop files designated by the user;
a modifying command provided for the user to select to modify one of the desktop files designated by the user; and
a switching command provided for the user to select to switch from the desktop file displayed on the operating system at the moment to another desktop file designated by the user.

5. The computer system as claimed in claim 4, wherein after the user selects one of the commands to change the desktop, the control unit informs the desktop management unit to update the desktop directory.

6. The computer system as claimed in claim 1, wherein the desktop files comprise a drafting desktop.

7. The computer system as claimed in claim 1, wherein the desktop files comprise a searching desktop.

8. The computer system as claimed in claim 1, wherein the memory further stores a plurality of data storage units corresponding to the desktop storage units, and each of the data storage units stores an icon file representing the icon.

9. The computer system as claimed in claim 8, further comprising:
a data management unit electrically connected to the control unit and storing an icon directory, the icon directory recording an address of the icon file stored in each of data storage units, wherein after the control unit receives an icon changing command transmitted by the operating system, the control unit reads the corresponding icon file in the memory according to the icon changing command and the icon directory, to display the icon file on the operating system.

10. The computer system as claimed in claim 9, wherein when the icon changing command is transmitted by the operating system to the control unit, a prompt window is shown on the desktop displayed on the operating system and is provided for the user to change the icon.

11. The computer system as claimed in claim 10, wherein the prompt window comprises:
an adding command provided for the user to select to add another icon file;
a deleting command provided for the user to select to delete one of the icon files designated by the user; and
a modifying command provided for the user to select to modify one of the icon files designated by the user.

12. The computer system as claimed in claim 11, wherein after the user selects one of the commands to change the icon, the control unit informs the data management unit to update the icon directory.

13. The computer system as claimed in claim 1, wherein the desktop changing command is a mouse controlling signal.
